(19) United States
(12) Patent Application Publication
(10) Pub. No.: US 2004/0117409 A1
(43) Pub. Date: Jun. 17, 2004

(54) Application synchronisation

(76) Inventors: Francis J Scahill, Ipswich (GB); Simon P A Ringland, Ipswich (GB); Timothy J Twell, Ipswich (GB); Richard Wiseman, Ipswich (GB)

Correspondence Address: Nixon & Vanderhye, 8th Floor, 1100 North Glebe Road, Arlington, VA, 22201-4714, US

(21) Appl. No.: 10/471,765

(22) PCT Filed: Apr. 2, 2002
(86) PCT No.: PCT/GB02/01520

(30) Foreign Application Priority Data
Mar. 3, 2001 (GB) 0108044.9

(51) Int. Cl. G06F 12/00

(52) U.S. Cl. 707/200

(57) ABSTRACT

The invention relates to multi-modal computer interfaces and the synchronisation of two or more application programs which have user interfaces which make up the multi-modal interface. The invention employs a synchronisation server process with blackboard style data store for posting the changes made to any one particular application program to the other application programs. Data updates pass via the synchronisation server. A map file is provided for translating data provided by one application program into the formats suited to other application programs, and vice versa. In this way, application programs are not limited by a common dialogue but are autonomous, thus providing a cohesive and highly flexible user interface.

The invention relates to computer interfaces, particularly the synchronisation of two or more application programs which have user interfaces. The invention may be employed to synchronise application programs having interfaces which use different input modalities. Each interface may employ a particular input/output mode to provide, in combination, a so-called multi-modal interface. Examples of input modes are keyboard, mouse, pen or speech while output modes may include visual display unit (VDU) or an audio output device such as a loudspeaker.

A multi-modal interface allows the user to interact with a computer in an intuitive and fluid way, which should lead to faster task performance with fewer errors. A uni-modal interface has certain advantages and weaknesses: speech is a rapid way of inputting large amounts of information, although it is difficult to unambiguously describe the position of an object with the spoken word. A keyboard or mouse is highly accurate in this sense; audio output is the only realistic way of providing music or pronunciation dependent information, but can be a long-winded way of delivering lists of information, in which instance screens are the best approach. A multi-modal interface is therefore able to capitalise on the advantages of each of the component uni-modal interfaces. An example multi-modal interface may be conceived as a WAP-enabled mobile telephone accessing a ticket booking application. The user navigates WML pages in the normal way to reach a (visual) list of performances, then selects and books a particular performance orally by dialogue with a VoiceXML interpreter. An interface such as this is can be considered “sequentially multi-modal” because only one mode is active at any given instant. The constituent uni-modal interfaces are said to be “uncoordinated” because values entered at one interface are not transferred to the other.)

WO 99/55049 (Northern Telecom Limited) describes a system for handling multi-modal information. A central service controller processes information received from various uni-modal interface programs. The central service controller decides on an appropriate output for each interface and this may involve retrieving information from the internet. The multi-modal system is highly centralised, where the control logic and data retrieval function are provided by the central service controller. For these reasons the system is inflexible; the user has no freedom to choose which mode of input to employ, while the service designer must be familiar with high level language of the central service controller dialogue if the system is to be modified, for instance to accommodate a new interface application program.

In a first aspect the present invention provides a system of apparatus for synchronising a group of application programs which together provide a multi-modal user interface, the system including;

processing means in communication with, via one or more communication links, the group of program applications, wherein each of the program applications is capable of communicating data with the processing means, wherein changes in the status and data content of the application programs are communicated to the processing means as data updates, the processing means having means to translate the received data updates into the format or formats suitable for other application programs of the group, and the processing means being configured to communicate the original or translated data updates as appropriate to the other application programs of the group so as to synchronise them.

The processing means or server of the present invention undertakes no control of the dialogues within individual application programs; it is merely a router for information between application programs where each application undertakes its own dialogue according to its own content. This dialogue may involve forcing changes in the dialogues in other application programs, for instance requesting a page in a web browser type interface may force a page update in other web browser type interfaces in the group.

In accordance with a further preferred embodiment of the present invention there is provided a system for synchronising application programs in which means are provided to allow a further application program to join the group of application programs upon receipt of a request to do so.

The ability to introduce new application programs into the group during a session allows the system to adapt dynamically the interface in response to, for instance, user requirements, system requirements or conditions such as changes in network bandwidth.

A user may decide that the session would be made more productive by using a Personal Digital Assistant and bring this device into the group. A web browser would be able to consult data held in a spreadsheet if necessary. Application programs may leave and join the group at under the control of the processing means or server (possibly initiated by user action) to the extent that all application programs can leave the group; for instance if there is a local power failure and the application programs are terminated, the session may be continued at a later time by logging back into that session which would still be active within the processing means or server.

By “active” is meant either that the session has not timed out and that application programs (clients) can [re]join the session, or that the session has timed out but was saved to a database (or similar) for future retrieval, so is still available for use.

Each application program is free to obtain information from the internet without passing through the processing means or server, while only information that is relevant to other application programs needs to be notified to the server. Complex dialogue control is effectively distributed, which reduces the load on the processing means or server. This has significant performance advantages over routing everything through a central service controller.

A further advantage is that content developed for this architecture can be used on a single application program without the need for the server at all. This degree of independence offers significant advantages for integration with uni-modal legacy content. It also means that it is possible to test each mode independently and content can also be created independently for each mode and content creators are free to use their preferred content creation tools.

A further advantage of embodiments of the present invention is that some of the functionality of the processing means or server can be transferred entirely to the client if necessary.

In a further preferred embodiment of the invention there is provided a system for synchronising application programs wherein mapping means are provided for mapping data received from one application program into a form suitable for use by the other application programs of the group.

To achieve synchronisation, it is necessary to know which page each application program should display and to perform conversion between corresponding form fields of each application program. To this end, a preferred embodiment of the system uses an XML-based document (a “mapfile”) to describe these two types of mapping.)

The content retrieved from the internet may be another map file document which may be used to augment or replace the existing map file for the group.

In a second aspect the invention provides a method of synchronising a group of application programs which together provide a multi-modal user interface, the method including the steps of:

(i) monitoring an application program for application program data values, said application program forming part of the group of application programs; and

(ii) upon detecting an application program data value, transmitting said application program data value to a synchronisation manager;

(iii) translating said application program data value into one or more formats suitable for use by the other application programs of the group; and

(iv) transmitting the application program data value in original or translated form to other of the application programs of the group.

Embodiments of the invention will now be described, by way of example only, with reference to the figures, where:

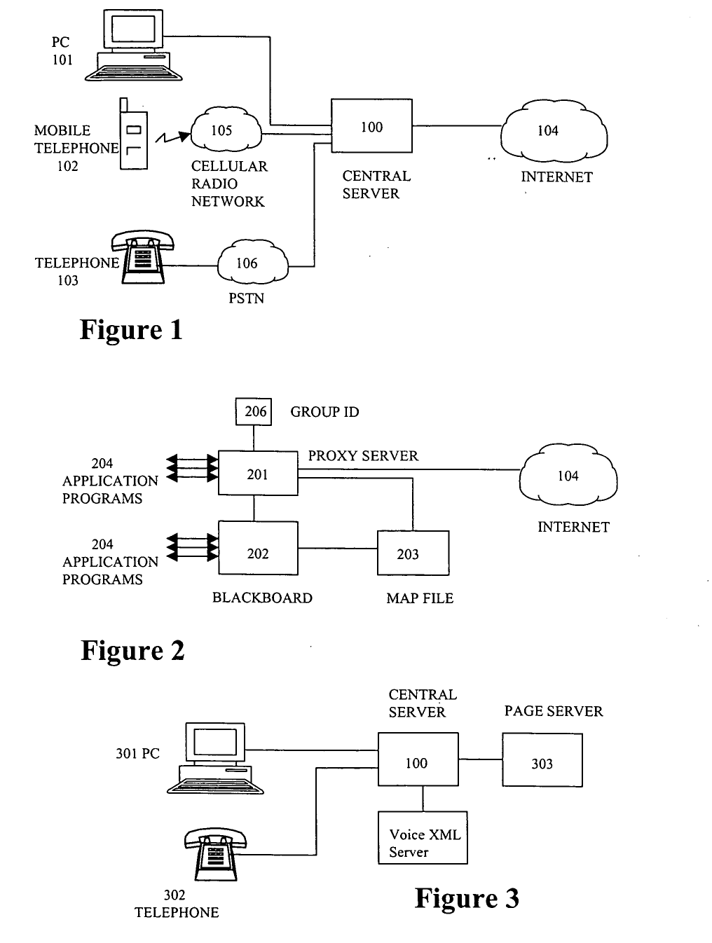

FIG. 1 is a schematic representation of the system;

FIG. 2 is a schematic representation of the components of the server; and

FIGS. 3, 4, 5 and 6 are schematic representations of examples of implementations of further preferred embodiments of the invention.

A preferred embodiment of the present invention is shown in FIG. 1 and takes the form of a system comprising a group of application programs in communication with a server 100. It is the task of the server 100 to synchronise the operation of the application programs currently running as a group such that individual application programs act cooperatively, each enjoying a certain degree of independence from the others in the group. Each of the application programs may be supported by a variety of hardware platforms, for instance an HTML web browser running on a PC 101, a WML browser running on a WAP enabled mobile telephone 102 or a voice browser using a telephone 103 as an interface. The voice browser could be entirely on the client, assuming that the client has enough processing power to perform speech recognition, or it could (and is more likely to be) networked somewhere else. In this latter case, the user could be speaking to it via a telephone, using Voice-over-IP, or through some kind of recognition front-end that pre-processes the speech before sending it for recognition to the network-based browser (thereby reducing that browser's load).) In the preferred embodiment, a group of application programs may comprise any number or combination of application program types. It is also desirable for the system to allow an application program to join or leave the current group without having to close down and restart the system. If there is no mechanism for an application program to exit its group, then the user will have to wait for it to time out before attempting to join another group (because it will automatically rejoin the same group). Restarting the application program (or the server, though this of course has other repercussions) prevents it from being identified by the server, since (in the HTTP case) its session cookie will have been invalidated.) A new application program may be requested by a user, for instance in the case where use of a personal computer (PC) is required in addition to a mobile phone in order to display a map. A new application program may be requested by an application program which is already a part of the group or a new application program may be requested by the processing means or server 100, for instance if network congestion is detected between a wireless communication link the server may decide to switch from using an HTML browser to a lower bit rate browser such as a WML browser. The user may want a particular browser of theirs to join the group, so uses whatever mechanism to achieve that. (This might be to say a particular phrase, or click a control button, or such like.) The server might know from the mapfile that it needs a particular type of browser to join the session (perhaps to display a street map or picture), so will ask the user if it is permissible to bring the appropriate application program into the group.

The user interface for each application program is dependent upon the hardware platform that is being used to run; thus, different input and output modes are supported by different platforms.

A dialogue between the application program and the user takes place via the user interface. It is also possible for an application program to require input from another application program, this input being received via the server 100.

Each of the application programs is connected to a server 100 by means of a communication link. The nature of the communication link between an application program and the server 100 is determined by the hardware supporting the application program. For instance, the communication link could be via a copper cable to connect a PC 101 to the server 100, or via a cellular radio network 105 to connect a mobile telephone 102 to the server 100, or via the PSTN 106 to connect a telephone to the server 100. The server 100 may also be connected to a further data source such as the internet 104, thus acting as a proxy server or portal, able to supply data such as web page content to any of the application programs should it be so requested.

Software for allowing an application program to communicate with the server 100 may either be provided already as a part of the application program or it may be downloaded from the server 100 when the application program joins a group.

The configuration of the server 100 will now be described with reference to FIG. 2. The server is responsible for the synchronisation of the operation of the application programs in a group. The server 100 comprises a proxy server 201 which is in communication with each of the application programs and also has a connection to the internet (because that is generally where the content pages will be stored—on a server somewhere, probably accessible by HTTP) 104 and to a group information source 206. The proxy server 201 is responsible for joining application programs to a group and for ensuring that only application programs which belong to the same group are synchronised together. The proxy server 201 is also able to retrieve data from other data sources such as the internet as and when requested by the application programs.

The server 100 is also provided with a blackboard 202 in communication with the application programs and in communication with the proxy server 201. The blackboard is essentially a mirror of the data of all clients supported by the particular application. Whenever a form field on a particular client changes, that client sends the new information to the blackboard, which converts it as appropriate so it can be displayed on the other clients and then pushes the new information to all other clients in the group. The push can be achieved through a variety of means, including the option of the client requesting a list of updates. Since copies of all form fields for all supported client types are stored on the blackboard, if a client joins part-way into a session, any of its form fields that have already had values supplied will be filled in from the blackboard. The blackboard 202 acts as a forum whereby a change in state of any one of the application programs in a group is announced and the remaining application programs of the group may retrieve information concerning this change of state from the blackboard 202. The blackboard 202 always holds a list of the information status of each of the application programs in the group. This information is always present in the blackboard which allows an application program to drop out of the group and re-enter a session later. The entire group may also to drop out of a session and pick up where it was left off at a later time. The blackboard 202 may also include information on the status of application programs which were not part of the initial group but which are in fact supported by the system, thus allowing an application program to join the group at a later stage. The proxy server 201 and the blackboard 202 have access to a map file 203. The map file 203 is a table of instructions on how data entered in one application program may be converted into data which is suitable for use in the other application programs of the group. The map file 203 will contain information such as, for example, algorithms which translate date fields between application programs, tables of equivalent URL's, etc. The mapfile contains information on: (a) which browser types are handled by the mapfile; (b) input control, i.e., which browser types can change the page being viewed, which can provide form field values, and which can control the field that currently has focus (all these can be overridden on a per-page or -field basis); (c) which form fields should be synchronised and how to convert between them; and (d) event handling (the implementation of which still needs to be finalised).). Each application program in a group will execute an internal dialogue with the user and the map file 203 will translate the user inputs (i.e. translate a request for a page by one client to an instruction to load a page by another client (possibly of a different type). It also means that it will convert a form field's value to fill in other clients' corresponding fields, and these new values will be “pushed” out to the other clients in the group.) which allows the other application programs to be updated with the corresponding information. Thus even if the user actually interacts with only one application program in a group, every other application program is updated (more or less simultaneously) so that the user may arbitrarily turn from one interface to another without a discontinuity of service arising. It is of course possible to be using two modes simultaneously, since one could be talking and clicking a checkbox at the same time.

Joining an existing group may be by Session Initiation Protocol (SIP) invitation. The Session Initiation Protocol (SIP) is an application-layer control protocol for creating, modifying and terminating sessions with one or more participants. These sessions include Internet multimedia conferences, Internet telephone calls and multimedia distribution. Members in a session can communicate via multicast or via a mesh of unicast relations, or a combination of these. SIP invitations used to create sessions carry session descriptions which allow participants to agree on a set of compatible media types. SIP supports user mobility by proxying and redirecting requests to the user's current location. Users can register their current location. SIP is not tied to any particular conference control protocol. For details of SIP, see Internet Official Protocol Standards, Request For Comments No.2543.

During a session an application program may join the group. Upon receiving a request for an application program to join a group the proxy server will issue the new application program a group ID which the new application program will use when interacting with the server 100. In this way the new application program will receive notification of updates from the blackboard 202 and will be able to retrieve relevant data there from. The request for a new application program to join the group may originate from the new application program itself or such a request may be generated by the dialogue of another application program which is already a member of the group. In addition, the proxy server may decide that is appropriate to bring another application program into the session.

The invention will now be further described with reference to an example which is illustrated in FIG. 3. An HTML-based web browser running on a Personal Computer (PC) 301 is provided, wherein the computer's usual screen, keyboard and mouse arrangement provide the user interface. A VoiceXML-based browser is also provided with telephone 302 providing a user interface. The HTML browser and the VoiceXML browser in this example constitute the application programs referred to previously in the description. In the example the browsers are synchronised at the page level such that requesting a new page using one type of browser causes the equivalent page, if it exists, to be pushed to the other browser in the group. Page level synchronisation is achieved by having all requests for (synchronised—i.e., mapped) pages to be made via the proxy, which uses the mapper and blackboard to instruct clients to load their corresponding page (using the same mechanism as when new form field values are pushed to the clients). Browsers are further synchronised at the event level such that data entered in a form element of one browser may be used to update any corresponding form elements in the other browser. In this way the browsers are kept current and the user may alternate between browsers according to personal preference.

As shown in FIG. 3 the system in the preferred embodiment comprises a server 100 (which contains 201,202, 203 and 206) in communication with the two browsers. The system requires a minimum of modifications at the client side and any modifications are automatically provided by ECMAScript or a Java Applet from the web server. On some clients, pages that are to be synchronised are parsed and altered (to catch events as the user interacts), but that can be achieved automatically. It may be necessary with a browser such as Internet Explorer to get the user to change the caching policy of the browser (to check for new versions of documents every time they are loaded. It should not be necessary to install new software on the various devices, which contrasts with other approaches to multi-modal synchronisation where a special browser is required. In some embodiments of the invention the HTML browser should support frames as each web page requested by the browser is returned within a visible frame plus a further three non-visible frames for synchronising the page elements of the HTML browser with the page elements of the VoiceXML browser. The function of each of the three frames will be described in more detail below. In alternative embodiments of the invention, HTML browsers open a new window to display the content, and use an applet instead of hidden frames.

The server (which contains the proxy server) 100 provides a portal to the web and also provides means for synchronising pages and the page elements of each browser type. The proxy server 201 is able to communicate with at least one page server (nominally by HTTP requests, and the page server can be anywhere on the internet that the server can “see”; it could be local, even the same machine.) 303 in order to retrieve content requested by the browsers. The proxy server 201 is able to request pages and receive the requested pages from the page server 303 and is enabled to push pages to the HTML browser. Furthermore, each of the two browsers is able directly to request content from the page server 303 (the page server is somewhere on the internet, so if the clients can “see” it, they can request pages directly from it rather than via the server). This reduces the computational load on the proxy server 201.

The map file 203 comprises a look-up table which is used to map URLs between HTML and VXML browsers. When a browser requests a new page the map file is referred to by the proxy server 201 to establish which other pages are required to update the other browser in the group. Conversion between pages need not be linear, in that a single page in one browser type may be equivalent to numerous pages for another browser type. The map file 203 further contains instructions on how page elements are to be mapped between browser types, for example date fields, quantities, addresses. It will be appreciated that it is the map file 203 which allows the uni-modal interfaces to cooperate. Thus the service designer may create a dialogue for each of the component browsers and an appropriate map file 203, executed in XML, which translates messages between the browser types. It is beneficial that a service designer may construct this multi-modal interface using standard software editing techniques. The independence of each browser allows a user to select an appropriate input modality; restrictions imposed on the user during the session arise from the limitation of the dialogue of a particular uni-modal interface and not through the relationship between uni-modal interfaces.

Page level updating of the browsers in a group is the responsibility of the proxy server 201 while event level updating is handled by the blackboard 202. The proxy server 201 and the blackboard 202 refer to the map file 203 in order to convert between browser types.

Using an HTML browser the user starts a session by entering the URL to visit an application program's homepage.

The start-page for the chosen application is returned by the proxy server 201.

A single HTML document containing the frameset is returned. Individual frames within the frameset are then loaded from the proxy server 201. The HTML frameset comprises a main, visible frame, in which the application content is displayed, and three hidden frames. The first of the hidden frames, called the function frame, contains the JavaScript code necessary to add event handlers content pages, to send form field values and focus events to the blackboard. The second hidden frame, called the update frame, is used essentially as a receptacle in which output from the server is placed when updates are sent from the application program to the blackboard 202. The third hidden frame, the monitor frame, monitors the blackboard 202 for activity of the other browsers; this is done by opening a connection to the blackboard 202, the response for which will be forthcoming when an update from the blackboard 202 is necessary, after which the same URL is reloaded ready for the next update. The URLs accessed by the update and monitor frames are implemented as Java servlets; the functions frame is static HTML containing JavaScript code.

The first page that is actually displayed in the main content window is a holding page with an animation to indicate that the system is working; the actual start page's URL is placed onto the blackboard 202. When the applet which is used to communicate between the HTML browser and the blackboard 202 makes a request to the MonitorBlackboard servlet for any updated information; since the start page URL has been placed onto the blackboard 202, it is returned and loaded through the proxy server 202.

The user then fills in the form elements of the web page using the mouse and keyboard. When the user moves the cursor to a particular form element a focus event is sent to the blackboard 202 by the UpdateBlackboard servlet which indicates that the particular element is active. (The JavaScript “focus” event is captured for each element using the “onfocus” event handler, which forces the UpdateBlackboard servlet's URL with an appropriate query string to be loaded into the update frame. The query string indicates to the blackboard 202 on which field it should be focussed.) In this way any other browser can focus on the corresponding element; when the user provides a value for an element, that is also sent to the blackboard 202 by the UpdateBlackboard servlet.

The user clicks a “Next>>” link and a request for the page is made to the proxy server 201. The proxy server 201 refers to the map file 203. If the page is not in the map file 203, content is returned only to the requesting browser since it cannot be synchronised. If the page is in the map file 203, a blank page is returned instead of the requested content page and the URL of the requested page is put onto the blackboard 202; this is then retrieved by the currently-waiting call to the MonitorBlackboard servlet and the page is loaded to the HTML browser. Requested pages are retrieved in this way because the implementing JavaScript is not able to properly synchronise events. If this approach is not used, information is retrieved from the blackboard 202 and used before the current page is unloaded. Other approaches can of course be used. As those skilled in the art will know, all client-server communication (and some in-server communication, to aid distributability) is event-based. One result of this is that the server expects a “document loaded” event when a document has finished loading; the server will not send out form field updates (which are also sent as events) to that client until it has received such an event.

At this point, the user decides to bring a voice browser into the session. He may do this by simply phoning the voice browser, which recognises his phone number (via CLI) and presents him with a list of groups he is permitted to join, from which he selects one (or if there's only one such group, perhaps joining him into that one straight away). The voice browser immediately goes to the VoiceXML page corresponding to the displayed HTML page. This happens because the server knows what page each client should be on, based upon the contents of the mapfile. The VoiceXML browser makes a request to the proxy server 201 using the same group name as is already being used and is joined into that group. The current page is already known for the group, and the VoiceXML version of it is returned to the voice browser. Since VoiceXML has no equivalent of frames or applets, it is not possible to have a MonitorBlackboard servlet waiting continuously as with the HTML browser. Instead, the VoiceXML code makes repeated calls to the blackboard 202 to make sure it has the most up-to-date information. Such a call is made as soon as the page is loaded to ensure that any information already known is asked for. In this example, there are no values to be updated in the VoiceXML form. (VoiceXML has form fields it must fill, and to do this, it goes through them until it finds one it has not yet filled; it then tries to fill that in by interacting (in the manner specified in the VoiceXML) with the user. When that has been done, whether or not the field was successful filled, it goes back to the start and looks again for the first unfilled field. (If it was unsuccessful at filling in a particular field, it will (in the absence of external influences like the system of the invention or embedded ECMAScript) try to fill that field again.) New values are checked for before or after each such cycle, hence the reference to repeated calls.

When asked orally via the VoiceXML browser for his date of birth, the user chooses to speak that information and at the same time uses the mouse and keyboard to enter the age ranges of his children. The UpdateBlackboard servlet is called in rapid succession by the two browsers, in this case by the HTML browser first because it is quicker to click on a menu item than speak a date. As soon as the date is placed onto the blackboard 202, the HTML browser's waiting MonitorBlackboard servlet request is provided with the new information and the HTML form is updated. Every time the VoiceXML browser sends information to the blackboard 202, it is returned with updated information—so as the children's ages reached the blackboard 202 first, this information is returned to the VoiceXML browser when it supplies the date to the blackboard 202, and therefore there is no need for the VoiceXML browser to request children's ages from the user. The date is automatically entered into the HTML form, and the voice browser is informed of the children's age ranges.

The user is then orally prompted for his e-mail address, which he chooses to type. The user is then asked whether he wants the information he has entered to be emailed to him, and rather than using the mouse to clear the checkbox on the HTML form he chooses to say “No.”—the checkbox is cleared automatically. The information is sent to the blackboard 202 via the UpdateBlackboard servlet and the HTML browser's waiting call on the MonitorBlackboard servlet is then informed of the new information, which is updated in the HTML form.

The voice browser no longer has any more information to collect, so asks the user whether the displayed information is correct. The user is free to go back and forth between the pages using the links as all the previously-entered information will be filled in automatically for each page. The user can either reply orally “Yes” or click the “Submit>>” link in the HTML browser. He opts to say “Yes” and the voice browser requests and loads its next page; this request causes the HTML browser to load its corresponding page.

The voice browser requests a synchronised page i.e., one that is included in the map file 203 and the page is returned. The URL of the new page is placed onto the blackboard 202 and the appropriate page change information is passed to the HTML browser's waiting MonitorBlackboard call and the HTML browser loads the new page. The user can then exit the system by clicking the HTML browser's “Exit” button and hanging up on the voice browser. Each browser's session cookie is expired by the proxy server 201 and static exit page is loaded.

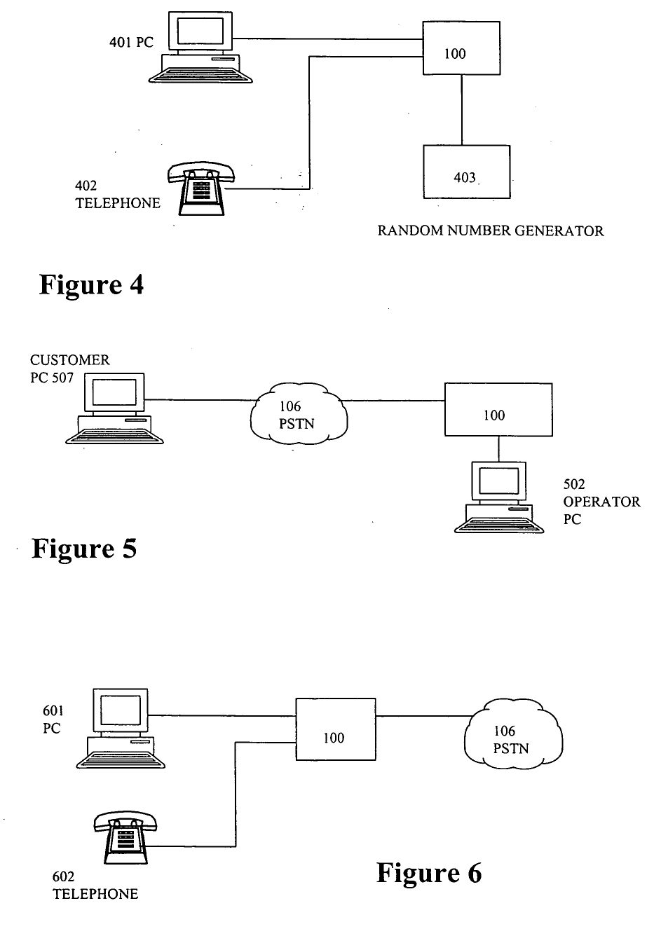

FIG. 4 shows a further example of an implementation of the present invention there is provided a PC 401 running an HTML browser, and a telephone providing a user interface to a VoiceXML browser. In this instance the user has chosen to play an on-line game of Roulette using an HTML browser running on PC 401 and a VoiceXML browser, the interface to which is provided by telephone 402. A further random number generator application 403 is also involved. The game itself takes the form of a Java applet loaded into the HTML browser from the proxy server 201 when the user makes a request to start the game. An HTML page containing the Java applet is loaded into the browser running on the PC 401; the applet uses another, communications applet to communicate with the server, which means that it can send and receive data values from the blackboard (in the server 100). The VoiceXML browser (resident somewhere on the network, not in the server 100 as suggested by the diagram) joins the same group of which the HTML browser running the applet is a member. The user can use the mouse to drag chips onto the applet's roulette board, can speak the bet (e.g., “£20 on black”) or can click and speak (e.g., £100 here). When the user clicks the roulette wheel or says “spin the wheel”, the random number generator 403 is accessed by the server 100 (for example, by means of an HTTP call, or via Java's RMI) to determine where the ball lands; the voice browser then announces whether or not the user has won anything, and the applet's view updates accordingly. The process of betting and spinning the wheel can then start again.

In a further example of an implementation of the present invention, shown in FIG. 5, a multimedia call centre is provided, the system comprising a customer PC 501 in communication with a server 100 via a public service telephone network (PSTN) 106, and an operator PC 502, where both the customer PC 501 and the operator PC 502 run HTML browsers. A domestic customer may dial the server via the PSTN 106 in order to request assistance with a particular issue, such as requesting information or to purchase consumable items of a nature appropriate to the needs and desires of the customer and his/her family. The server then invites an operator to join the session and the customer may then communicate freely with the operator. In order for this to work as described, the server would need to have information linking the customer's phone CLI with their current group. Alternatively, the customer could have to enter something via the phone (either by voice or by IVR) to identify the group to which their browser belongs. The phone connection could then be automatically directed to the appropriate operator so that the operator and customer can speak to each other; and the operator would receive an invitation to join that customer's group, thereby linking their browsers.

In a further example of an implementation of the present invention, shown in FIG. 6, a call steering application is envisaged, whereby a call steering dialogue is implemented using Interactive Voice Response technology employing an ordinary telephone 602 as an interface. By providing the server 100 as coordinating means, the user may track the progress of the call using an HTML browser on a PC 601 and may enter information at any stage of the process. This has the effect of enhancing the essentially serial decision tree-type nature of the IVF into a parallel interface.

1. A system of apparatus for synchronising a group of application programs which together provide a multi-modal user interface, the system including;
processing means in communication with, via one or more communication links, the group of program applications, wherein each of the program applications is capable of communicating data with the processing means, wherein changes in the status and data content of the application programs are communicated to the processing means as data updates, the processing means having means to translate the received data updates into the format or formats suitable for other application programs of the group, and the processing means being configured to communicate the original or translated data updates as appropriate to the other application programs of the group so as to synchronise them.

2. A system as claimed in claim 1, wherein at least one of the application programs of the group provides a visual interface and at least one of the application programs provides a speech interface.

3. A system as claimed in claim 1 or claim 2, wherein memory means are provided to store received data updates for the processing means, further memory means being provided to hold rules for the translations to be performed.

4. A system for synchronising application programs according to any one of the preceding claims, wherein the system is configured to allow a further application program to join the group of application programs upon receipt by the processing means of a request to do so.

5. A system for synchronising application programs according to any one of the preceding claims wherein at least one of the application programs is a web browser.

6. A system for synchronising application programs according to any of the preceding claims wherein mapping means are provided for mapping said data received from one application program into a form suitable for use by the other application programs of the group.

7. A system for synchronising application programs according to claim 6 wherein the mapping means uses a synchronisation mark-up language.

8. A system for synchronising application programs according to claim 7 wherein the synchronisation mark-up language uses extensible mark-up language.

9. A system for synchronising application programs as claimed in any one of the preceding claims, wherein the processing means is in communication with means suitable for retrieving web pages.

10. A method of synchronising a group of application programs which together provide a multi-modal user interface, the method including the steps of:
(i) monitoring an application program for application program data values, said application program forming part of the group of application programs; and
(ii) upon detecting an application program data value, transmitting said application program data value to a synchronisation manager;
(iii) translating said application program data value into one or more formats suitable for use by the other application programs of the group; and
(iv) transmitting the application program data value in original or translated form to other of the application programs of the group.

11. A method as claimed in claim 10, wherein the synchronisation manager carries out a process between steps (ii) and (iv) to decide to which of the application programs application program data should be transmitted in step (iv).

12. A method as claimed in claim 10, further including the steps of:
(v) the synchronisation manager notifying the other application programs in the group that an application program data value data has been received in step (ii),
(vi) in response to the notification of step (v) receiving a request from any or all of the other application programs in the group for a copy of the application program data value;
(vii) in response to a request received in step (vi) carrying out step (iv) in respect of the or each requesting application program(s).

13. A method as claimed in any one of claims 10 to 12, wherein the synchronisation manager maintains a store of the application program data values received in step (ii)

14. A method of synchronising a group of application programs according to any one of claims 10 to 13, comprising the step of introducing a further application program to the group of application programs.

15. A method of synchronising a group of application programs according to claim 14, wherein a request is made to the synchronisation manager for a further application program to join the group by the further application program.

16. A method of synchronising a group of application programs according to claim 14, wherein a request is made for a further application program to join the group by one of the group of application programs.

17. A method of synchronising a group of application programs according to claim 14, wherein the request is made for a further application program to join the group by the server itself in response to the detection of a change in status of an application program.

18. A method of synchronising a group of application programs according to claim 17, wherein the change in status is a fluctuation in the capacity of the communication link between one or all of the application programs in the group.

19. A method of synchronising a group of application programs according to any one of claim 10 to 18, including the step of referring to a synchronisation table in order to convert the user input data received from the user interface of one application program into data suitable for use in any one of the other application programs in the group.

20. A method of synchronising a group of application programs according to any of claims 10 to 19, further including the step of obtaining data from the internet upon request from any one of the application programs and transmitting this data to the application program which made the request.

21. A method of synchronising a group of application programs according to claim 20, including notifying the other application programs in the group that a request for data from the internet has been made, and
submitting a request from any or all of the other application programs in the group for a copy of the data, and
transmitting the requested data to each of the application programs that submitted a request.

22. A method of synchronising a group of application programs according to claim 20, including notifying the other application programs in the group that a request for data from the internet has been made, and
submitting a request from any or all of the other application programs in the group for a copy of the data, and
determining the suitability of the data from the internet for each of the application programs that made the request, such that
if the data is determined as not suitable for use by an application program then referring to the synchronisation table in order to determine the location of equivalent data on the internet which would be suitable for use by the application program, and;
retrieving the equivalent data from the internet and transmitting this data to the application program.
